(19) United States
(12) Patent Application Publication
(10) Pub. No.: US 2005/0089750 A1
(43) Pub. Date: Apr. 28, 2005

(54) Temperature control apparatus and method for high energy electrochemical cells

(76) Inventors: Chin-Yee Ng, Maplewood, MN (US); Scott D. Gullicks, Apple Valley, MN (US)

Correspondence Address: 3M INNOVATIVE PROPERTIES COMPANY, PO BOX 33427, ST. PAUL, MN, 55133-3427, US

(21) Appl. No.: 10/502,443

(22) PCT Filed: Dec. 19, 2002
(86) PCT No.: PCT/US02/40971

Related U.S. Application Data
(60) Provisional application No. 60/357,874, filed on Feb. 19, 2002.

(51) Int. Cl. H01M 10/50

(52) U.S. Cl. 429/120; 429/66; 429/62; 429/149

(57) ABSTRACT

An apparatus and method provides cooling for electrochemical cells of an energy storage device. A number of electrochemical cells are arranged in a spaced apart relationship, each having opposing first and second planar surfaces and being subject to volumetric changes during charge and discharge cycling. A cooling bladder provides temperature control for the energy storage device. The cooling bladder is formed of a conformable thermally conducting material and includes inlet and outlet ports. The cooling bladder conforms to maintain contact with at least the first planar surface or the second planar surface of each cell during volumetric changes of the cells. A heat transfer medium passes between the inlet and outlet ports of the cooling bladder to control an operating temperature of the cells. The cooling bladder can be pressurized to maintain the cells of the energy storage device in a state of compression during charge and discharge cycling.

### STATEMENT OF PRIORITY

This application claims dw priority of U.S. Provisional Appliion No. 60,357,874 filed Feb. 19, 2002, the contnts of which are hereby incorpored by refece.

### GOVERNMENT LICENSE RIGHTS

The Covemment of the United States of Ameinca has right in this invention pursuant to Cooperative Agreement DE-FG02-95EE50425 awarded by the U.S. Departent of Energy.

### FIELD OF THE INVENTION

The present invention relates generally to energy storage devices and, more particularly, to appatums Bud methods for controlling the temperature of high energy electrochemical cells dinig option.

### BACKGROUND OF THE INVENTION

The demand for new and improved clecmechanical Stems, such as hybrid-electric vehicles for example, has placed increased prssure on the manufactres of enegy storing devices to develop battery technologies that provide for high energy generation in a low-volume package. A number of advanced batey technologies have recently been developed, such as metal hydride (e.g., Ni-MH), lithium-ion, and lithium polymer cell technologies, which would appear to provide the requisite level of energy production and safety maroa for many commercial and consumer aplications. Such advanced batery technologies, however, typically osbibit dchracteisics that provide challenges for the manufacturers of advaed energy storage devices.

For example, advanced power generating systes typically prodcL a signicnt amount of heat which, if not property dissipated, can result in non-optimal performance of the system. Moreover, poor thermal managmmt of such cells can result in a thermal runaway condition and eventual destruction of the cells. The thermal charatertics of an advanced battery cell must therefoe be understood and appropriately considered when designing a battery system suitable for use in commercial and consumer devices and systems.

A conventional approach of prwviding a host fer mechanism external to a stack of advanced rechargeable electrochemical cels of an energy storage system, for example, may be inadquate to effectively dissipate heat from intemal portions of the cell. Such conventional approaches may also be too expensive or bulky in certain applications. The severity of consequences regulting from non-optimal performance, short-circuits, and themal run-away conditions increases significantly when advanced high-energy electrochemical cells are implicated.

Another conventional cooling approach involves immersing the entire electrocemical cell or portions of the elecochemical cell in te coolant. While this approach provides good thermal contact between the electrochemical cell and the coolant stream, sealing and electrical isolation issues are of considerable concern.

Other characteistcs of advanced battery technologies provide additional challenges for the designers of advanced energy storage devices. For example, certain advanced cell strutures are subject to cyclical changes in volume as a consequence of variations in the state of charge of the cell. The total volume of such a cell may vary as much as five to six perent or more during charge and discharge cycling. Such repetitive changes in the physical size of a cell significantly complicates the thermal management strategy of the energy storage systen.

Conventional battery systems, such as those that utilize lead acid cells for example, typically employ a cooling system that is implemented within the walls of the rigid battery casing, such as by use of cooling tubes within the walls of the casing. Other conventional approaches employ a cooling apparatus that contats the external rigid metallic casing of the cells of the battry system. In such cases, the cooling system can be relatively simple in design, in that any dimensional changes occuring within the cills have little to no consequences externally of the cells. For example, a change in electrode volume duing operation of such hard encased cdUi does not result in an a able change of the casing dimension of the cells, due to the rigidity and strength of the cells' casing. In applications employing advanced rechargrable electrochemical cells (in particular Lithium Ion, Lithium Polymer, Lithium Ion Polymer cells, for example) not contained by integral rigid cell casings, the cooling approaches and methodologies used in connection with cmnventional battery systems are of limited practical use due to large scale net external dimensional changes on the casing occurring over charge and discharge cycles.

There is a need in the advanced battey manufacturing industry for a power generating system that exhibits high-energy output, and one that provides for safe and reliable use in a wide range of applications. There exists a further need for a thermal management approach that effectively maintain energy storage cells at a nominal operating temperature and provides for optimal performance of such cells. The present invention fulfills these and other needs.

### SUMMARY OF THE INVENTION

The present invention is direct to an apparus and mothod of cooling elecochemical cells of an energy storage device. In accordance witb one embodiment of the present invention, an energy storage device includes a number of electrochemical cells arranged in a spaced apart relationship. Each of the electrochmical cells includes opposing first and second planar surfaces and is subject to volumetric changes during charge and discharge cycling, A cooling bladder is employed to provide temperature control for the energy storage device. The cooling bladder is formed of a conformable thermally conducting material and includes an inlet port and an outlet port. The cooling bladder conforms to maintain contact with at least the first planar surface or the second planar surface of each of the electrochemical cells during volumetric changes of the cells A heat transfer medium passes between the inlet and outlet ports of the cooling bladder to control an operating temperature of the electrochemical cells.

The cooling bladder can be fabricated to include a continuous hollowed interior within which the heat transfer mdium passes. In one configuration, the cooling bladder includes a number of flow channels within which the heat transfer medium passes. In general, the cooling bladder covets substantially all of the surface of each of the cclls.

According to one configuration, the ooling bladder includes a support arraangement that inhibits restriction of heat transfer medium flow at cooling bladder bend locations. The support arrangement can be located on an outer surface of the cooling bladder at cooling bladder bend locations. The support arrangemtent can also be located win the cooling bladder at cooling bladder bend locations. The support arrangement can firder be integrated with the cooling bladder construction at cooling bladder bend locIations.

For example, the cooling bladder may include a porous filler material disposed within the cooling bladder. The porous filler material can be disposed at cooling bladder locations subject to bending. In another approach the cooling bladder includes thickened sections provided at cooling bladder locations subject to bending.

The cooling bladder can be desiged to include an interor compartment within which the heat transfer medium passes between the inlet port amd the outlet port in a unidireational manner. The cooling bladder can also be designed to include a number of compartments through which the heat transfer medium passes, For examrple, the cooling bladder can include a first interior w t and a second interior compartment. The transfer medium passing within the first interior component preferably flows in a direction opposing that of the transfer medium passing within the second iterior compartment.

The cooling bladder can be constucted from a conformable thermally conductive material having a sile mateial layer or from a conformable thermally conductive material having a number of material layers. For example, the conformable thermally conductive material can include a metallic layer disposed between a first polymer layer and a second polymer layer.

The cooling bladder's conformable thermally conductive material preferabiy has a thickness of less than about 150 miIs. Advantageously, the cooling bladder and the heat tranfer medium preferably cstitute less than about 50% by weight or volume of a total aggregate weight or volumo of the calls, cooling bladder, and heat transfer medium.

The electrochemical cells of the energy storage device can be arranged to form a number of cell staks or sets. Each of the cell sets is provided with one of a number of cooling bladders, such that an operating temperature of electrochemical cells of each of the cell sets is controlled by at least one of the cooling bladders deployed in the energy storage device.

The eletrochemical cells of an energy storage device can be arraged to form a cell stack. In such a configuration, the cooling bladder controls the operating temperature of the cell stack such that a temperature difference as measured between any two cells of the cell stack does not exceed 5 degrees Celsius. The cooling bladder can also control the operating temperatore of the cell stack such that a temperature difference as measured between any two points on either the first or second planar surface of an individual cell does not exceed 5 degrees Celsius. More preferably, the cooling bladder controls the operating temperature of the cell stack such that a tomperature difference as measured between any two cells of the cell stack or between any two points on either the first or second planar surface of an individual cell does not exceed 2 degrees Celsius.

In accordance with one implementation, the cooling bladder conforms to a serpentine configuration to contact the respective first and second planar surfaces of each of the electrochemical cells of an energy storage device, By way of example, each of the electrochemical cells includes first, second, third, and fourth edges, such that the first edge opposes the second edge and the third edge opposes the fourth edge. The first and second edges of each electrochemical cell electrically couples to respective electrical conductors for conducting current into and out of each of the electroochemical cells. The cooling bladder contacts respective third and fourth edges and respective first and second planar surfaces of each of the electchemcal cells.

The heat transfer medium passed through the cooling bladder can be water, according to one approach. The heat transfer medium can also be a mixture of water and ethylene glycol or other anti-freeze, or a mixture of methanol and othylene glycol, The temperature of the heat transfer medium entering the inlet port of the cooling bladder is preferably substantially constant.

The cooling bladder preferably controls the operating temperature of electohemical cells of an energy storage device having operating tempcatures ranging between about 20 degrees Celsius and about 130 degrees Celsius. Tho electrochemicaI colls can be lithium cells or nickel metal hydride cells, for example.

According to a further embodiment, the energy storage device includes a housing within which the electrochemical cells and the cooling bladder are situated. The housing includes a positive terminal and a negative terminal each coupled to the electrochemical cells. The housing further includes an inlet aperture for providing access to the inlet port of the cooling bladder and an oudet aperture for providing access to the outlet port of the cooling bladder.

In one configuration, the housing contain the electrochemical cells and a number of cooling bladders. In addition to including a positive terminal and a negative terminal each coupled to the electrochemical cells, the housing further includes at least one inlet aperture for providing access to an inlet port of each of the cooling bladders and at least one outlet apertre for providing access to an outlet port of each of the cooling bladders. The number of cooling bladders and inlet and outlet ports may be selected to provide for various configurations of single, multiple, serial, and parallel flows, amd combions of such flows.

In accordance with another embodiment of the present invention, the cooling bladder is pressurized to maintain the eloctrochemical cells of the energy storage device in a state of comression during charge and discharge cycling.

In accordance with a further imbodimeent of the present invention, a method of providing cooling within an electrochemical storage device involves providing a number of electrochemical cells aranged in a spaced apart relationsbip, with each of the electrochenical cells including opposing first and second planar surfaces and subject to volumetric changes during charge and discharge cycling. A conformable, thermally conductive cooling bladder is provided, such that the cooling bladder conforms to maintain contact with at least to first planar surface or the second planar surface of each of the electochemical cells during the volumetric changes. A heat transfer medium is passed through the cooling bladder to control an operating temperature of the electrochemical cells. The method can further involve pressurizing the cooling blader to maintain the electrochemical cells in a state of compmression during cell charge and discharge cycling.

The above summary of the present invention is not intended to describe each embodiment or every inplemwentation of the preent invention. Advantages and attainments, together with a more complete understanding of the invention, will become apparent and appreciated by referring to te following detailed description and claims taken in conjuncton with the accompanying drawings.

### BRIEF DESCRIPTION OF THE DRAWINGS

FIG. 1 is an illstration of an energy storing system which employs a cooling apparatus according to an embodiment of the present invention;

FIG. 2 is an illustration of an energy storing system which employs a cooling apparatus according to anotler embodiment of the present invention;

FIG. 3 illusates a sub-assembly of the energy storing system of FIG. 2, with a more detailed showing of a cooling bladder of the present invention;

FIG. 4 is in illustration of a cooling bladder that employs top mounted inlet and outlet ports according to an embodiment of the present invention;

FIG. 5 is an illustration of a cooling bladder that employs side-mounted inlet and outlet ports according to an embodiment of the present invmention;

FIG. 6 is a detailed illustration of a cooling bladder according to an embodiment of the presnt invention;

FIG. 7 is a side view of the cooling bladder depicted in FIG. 6;

FIG. 8 illustrates a cooling bladder configuration according to an embodiment of the present invention;

FIG. 9 illustrates a cooling bladder configuration according to another embodiment of the present invention;

FIG. 10 illustrates a cooling bladder configuration according to a further ombodiment of the present invention;

FIG. 11 is an illustration of a string of electrochemical cells fitted with a cooling bladder in accordance with an embodiment of the present inventlon;

FIG. 12 is an illuatation of a string of electrochemical cells fitted with multiple cooling bladders in accordance with an embodiment of the present invention; and

FIG. 13 is an illustration of a simple parallel flow arrangement implemented within a cooling bladder of the present invention.

While the invention is amenable to various modifications and alternative forms, specifics thereof have been shown by way of example in the drawings and will be described in detail. It is to be understood, however, that tbe intention is not to limit the inventlon to de particular ewbodiments descibed. On the contrary, the intention is to cover all modifications, equivalents, and alternatives falling within the scope of the invention a defined by the appended claims.

### DETAILED DESCRIPTION OF VARIOUS EMBODIMENTS

In the following description of the illustrated embodiments, reference is made to the accompanying drawings which form a part hereof, and in which is shown by way of illustration, various embodiments in which the invention may be practiced. It is to be understood that the embodiments may be utlized and srtuctural changes may be made without departing from the scope of the present invention.

A temperature control apparatus and methodology of the present invention provides for enhanced control of energy storage device tomperatres during normal and cold start operaions. A temperat control apparatus and methodology according to the present invention is particularly well-suited for controlling the tempeature of high energy, high power density rechargeable electrochmical cells arranged in a spaced apart relationship, such as an arangement of lithium or nickel metal hydride prismatic cells defining a rechargeable module or battery, for example. Such rechargeable electrochemical cells are particularly well-suited for use in the construction of high cutrent, high voltage energy storage modules batteries, such as those used to power electic and hybrid-electric vehicles, for example.

Advanced rechargeable lithium and nickel metal hydride electrocheical cells, for example, are subject to significant volumetric chamges during charge and discharge cycling due to anode state changes, which renders conventional cooling approaches inaffectual or inadequate. Also, such advanced rechargeable bautteries generally require maintenance of uniform stack and cell pressures. lu conventional implementations, this is typically accomplished via a pressure system internal or external to the individual cells, such as a system of sprinngs, plates or pads.

Intimate contact between an arrangement of electrochemical cells and a temperature control apparatus of the present invention is advantageously maintained in the presence of significant cell expansion and contraction, which provides for enhanced temperature control, improved cell performance, and extend cell life. In energy storage device applications in which compressive pressure within a cell arrangemrnet (e.g., a cell stack arrangement or a cluster arranement) is needed or desired, the requisite cell stack pressure can be maintained during cell expansion and contraction by pressurizing the temperature control apparatus of the present invention. In sucb applications, a temperature control apparatus of the present invention advantageouly provides the requisite thermal and pressure control for an arrangement of electrochemical cells, thereby obviating the need for separate temperature and presure control systems.

In broad and general terms, a temperature cottrol bladder or pouch of the present invention (referred to herein as a cooling bladder, although cooling/heating bladder is equally applicable) is formed of a deformable, thermally conductive material through which a heat transfer medium passes. The coaling bladder can be readily manipulated during installion within a given cell stack arrangement, such that contact between surface of tho cell adacent the cells' active area and the cooling bladder is maximized. The deformable cooling bladder may be formed to take on a variety of shpes, sizes, and lengths to accommodate a wide variety of cell stack geometries. For example, the cooling bladder for a given cell stack arrangement may take on a continuous serpentine shape or a simple rectangular or square shape.

The cooling bladder of the present invention may have a single interior compartment within which the heat transfer medium is contained or a multiplicity of such interior compartments. The cooling bladder may be provided with a single inlet port and a single outlet port, in the case of a serial flow arrangement, or may have multiple inlet ports and multiple outlet ports, in the case of a prallel flow arrangement or an arrangement involving a multiplicity of serial or parallel flows. Single inlet-multiple outlet port configurations can also be employed, as an multiple inlet-single outlet port argments.

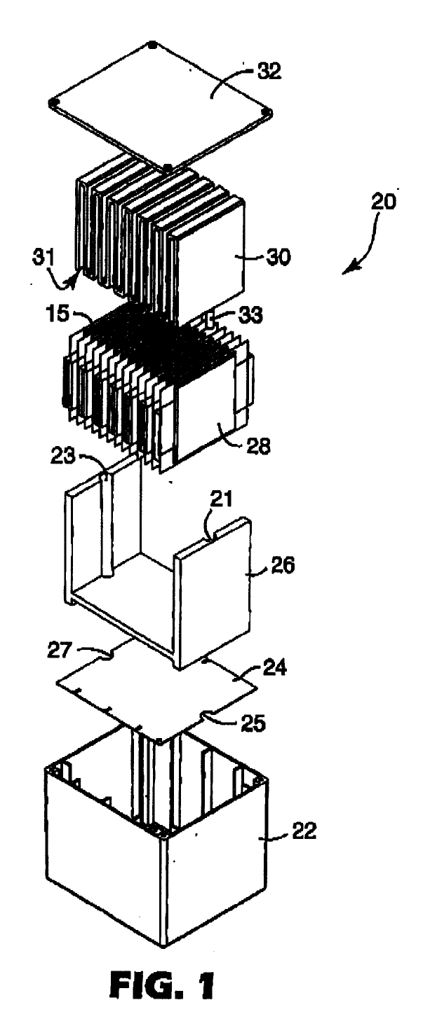

Referrig now to the figures, and more paricularly to FIG. 1, there is ilustratd an embodiment of an energy storap device 20 which employs a temperature control apparatus and methodology in accordance with the principles of the present invention. According to this embodiment, the energy storage device 20 includes a housing body 22 into which a circuit board 24 is mounted. The circuit board 24 includes positive and negative contacts tha are electrically coupled to respective positive and negative terminals attached to or extending through a side or sides of the housing body 22.

A foam insert 26 is positioned adjacent the circuit board 24. A cell stack assembly 28 is fitted within the foam in 26. The cell stack assembly 28 comprises a number of rechargeable electochemical cells 15. The electrochemical cells 15 are preferably of an advanced rechargeable technology and exhibit high energy and high power density attributes. In this configuratiom the cell stack assembly 28 includes electrical contacts which extend to connect with receiving contacts (not shown) provided on the circuit board 24. The connections between the cell stack assembly 28 and the circuit board 24 can be designed to provide desired parallel ad series conections between cells 15 of fhe cell stack assembly 29 to achieve a desired voltage and amperage for the energy storage device 20.

FIG. 1 further illustrates a cooling bladder 30 in accordance with embodiment of the present invention. The cooling bladder 30 depicted in FIG. 1 has been manipulated in this illustrations to have a generally serpentine shape to accommodate ie configuration of the coil stack assembly 28. The serpentine configuration of the cooling bladder 30 provides for easy integration within the spaced apart cells 15 of the cell stack assembly 28. The “fan fold ” cooling bladder configuration depicted in FIG. 1 allows portions of the cooling bladder 30 to be interleaved within the cell stack assembly 28, such that substantially all of the surface area of each cell is in contact with the cooling bladder 30.

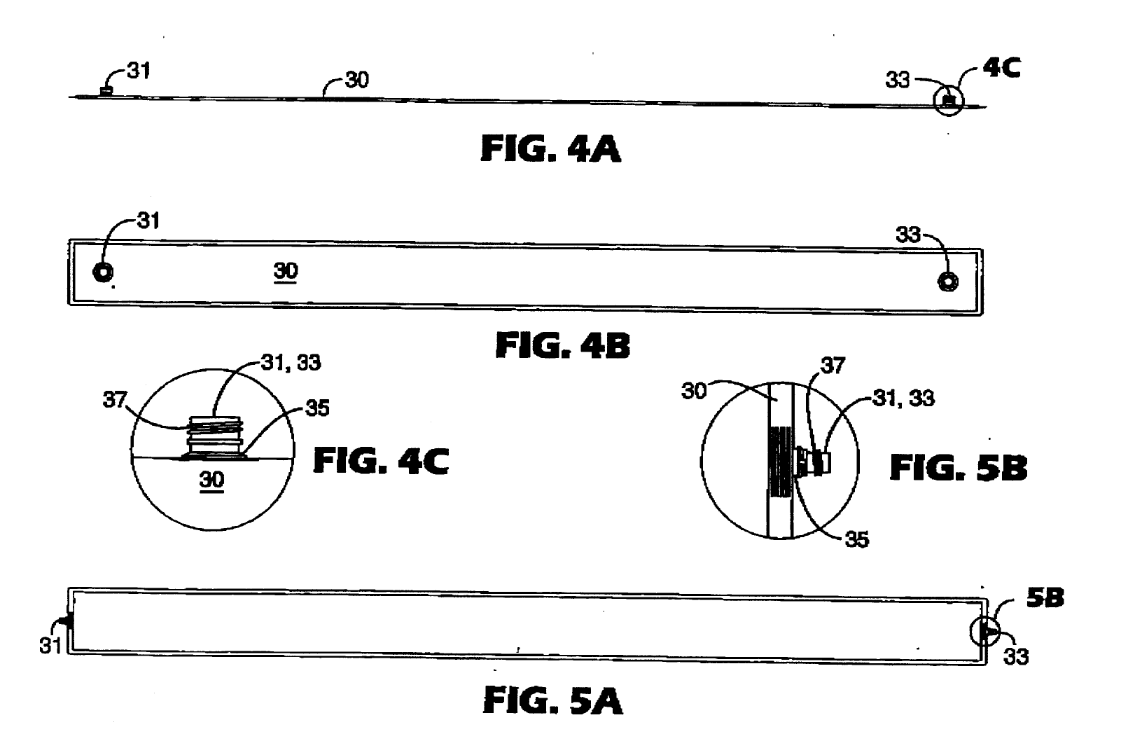

The cooling bladder includes an inlet port 31 (not shown in FIG. 1, but shown in FIGS. 4 and 5) and an outlet port 33. As shown, the outlet port 33 and inlet port 31 are tubular in shape, and respectively terminate at opposing ends of the cooling bladder 30. The foam insert 26 includes corresponding semicircular channels 21 and 23 that accomodate the outlet port 33 and inlet port 31 when the cell stack assembly 28 and cooling bladder 30 are properly installed in the foam insert 26. The circuit board 24 also includes semicircular notches 25 and 27 that respectively accommodate the outlet port 33 and inlet port 31 of the cooling bladder 30.

The outlet port 33 and inlet port 31 of the cooling bladder 30 extend through corresponding apertures (not shown) in the housing body 22. Alternatively, tubes or hoses extend through respective apertures in the housing body 22 and are connected to the outlet port 33 and inlet port 31 of the cooling bladder 30. After completing installation of the cell stack assembly 28 and cooling bladder 30 within the housing body 22, a housing lid 32 is secured to housing body 22. Hermetic or non-hermetic seals may used as required.

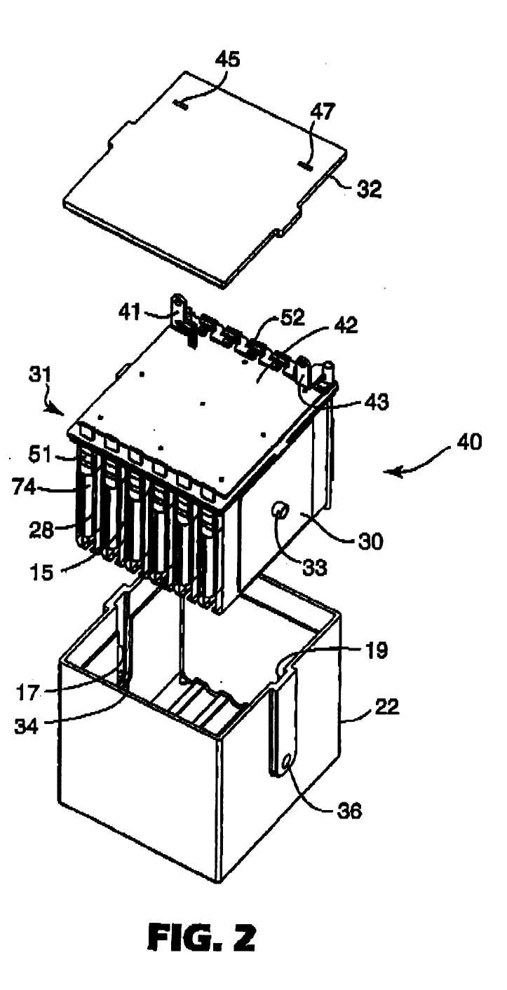

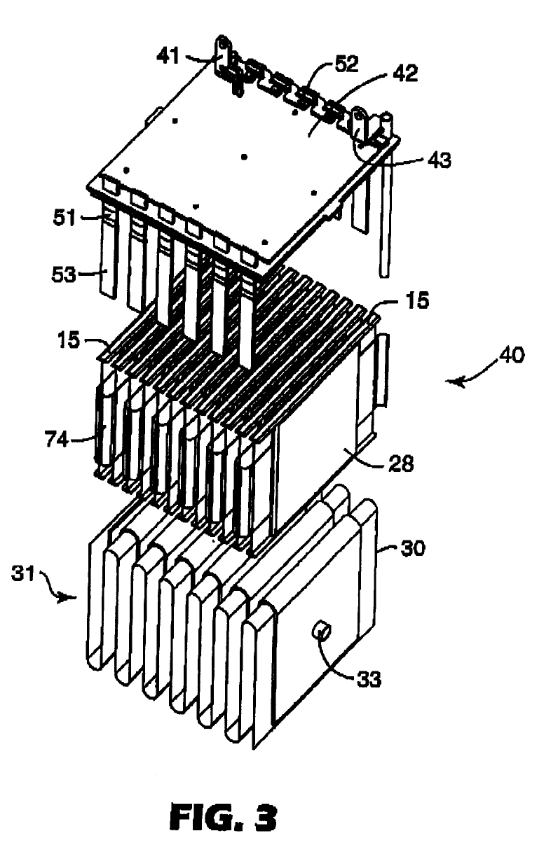

FIGS. 2 and 3 illustrate an alternative embodiment of an energy storage device 40. According to this embodiment, electrical connections between the energy storage device 40 and an external electrical system are established through the housing lid 32, rather then through the housing body 22 as in the case of the embodiment depicted in FIG. 1. The energy storage device 40 illustrateed in FIG. 2 and 3 includes a cooling bladder 30 of the present invention installed on a cell stack assembly 28 definedby a number of spaced apart electrochemical cells 15. In this configuration, the cooling bladder 30 is shown to include an outlet port 33 and inlet port 31 (not shown in FIGS. 2 and 3, but shown in FIGS. 4 and 5) that respectively terminate on the planar surface of the cooling bladder 30 near the opposing ends of the cooling bladder 30. As such, the outlet port 33 and inlet port 31 Lre arranged on the cooling bladder 30 to provide for side access through adjacent side walls of the housing body 22.

The housing body 22 is fabricated to include channels 19 and 17 that respectively accomodate outlet and ports 33 and 31 as the cell stack assembly 28 and cooling bladder 30 are installed into the housing body 22. An outlet aperture 36 and an inlet aperture 34 are provided in side walls of the housing body 22 to permit external connection to respective outlet and inlet conduits. When the cell stack assembly 28 and cooling bladder 30 are properly installed in the housing body 22, the outlet and inlet ports 33, 31 register with the outlet and inlet apertures 36, 34 of the housing body 22. Outlet and inlet conduits, such as hoses or the like, may subsequently be connected to the outlet and inlet port 33, 31. The inlet conduit provides a source supply of a heat transfer medium to the inlet port 31 of the cooling bladder 30, and the outlet conduit connected to the outlet port 33 provides a return path for the heat transfer medium after having passed through the cooling bladder 30.

According to this embodiment, the circuit board 42 is positioned on top of the cell stack assembly 28 adjucent the housing lid 32. The circuit board 42 includes a number of leads 51 to which a corresponding number of tabs 53 are attached. The tabs 53 extend from the leads 51 of the circuit board 42 and connect with tabs 74 of the cells 15 of the cell stack assembly 28. In a typical configuration, one of the circuit board tabs 51 provides electrical connection to one of the cell tabs 74. The cell leads 51 are preferably fabricated as copper bars and include a swaged flexible (e.g., braided) mid-section. The cell tabs 51 are preferably ultrasonically welded to the cell leads 51. The circuit board 42 may further include various electrical and/or electronic circuits 52, such as bypass circuitry, equalization circuitry, fuses, and the like.

In the embodiment depicted in FIGS. 2 and 3, positive and negative terminals 41 and 43 are electrically connected to the leads 51 of the circuit board 42, typically through electrical/electronic circuitry 52. The terminals 41 and 43 respectively register with apertures 45 and 47 of the housing lid 32. As such, external electrical connections with the energy storage device 40 are established through the top housing lid 32 of the energy storage device 40. The terminal apertures 45, 47 and the housing lid 32 may include hermetic or non-hermetic seals as a particular application may require.

The cells 15 of one or a number of the energy storage devices 40 can be elctrically connected to define an energy storage device which produces a desired voltage and current appropriate for a given application. For example, number of electrochemical cells 15 can be arranged in a stack configuration and interconnected to form larger power producing devices, such as modules and batteries for example. A grouping of electrochemical cells 15 may be selectively interconnected in a parallel and.or series relationship to achieve a desired voltage and current rating. For example, a number of electrochemical cells 15 may be grouped together and connected in parallel to common positive and negative power buses or terminals of the circui board 42 to form a cell stack assembly 28. A number of such stack cell assemblies 28 may the n be connected in series to form a module. Further, a number of individual modules may be connected in series constitute a battery. Such an arrangement of modules can be used to power an electric or hybrid-electric vehicle, for example.

The electrochemical cells 15 employed in the cell stack assembly 28 are preferably advanced rechargable (e.g., secondary) high energy and high power density batteries, such as lithium batteries and nickel metal hydride batteries. These batteries, when used in a multi-cell configuration with high discharge rates, typically genrate a significant amount of heat, which can result in thermal runaway, short circuiting, and eventual destruction of the batteries if not properly controlled.

Lithium batteries which can advantageously be employed in an energy storage device incorporating a cooling apparatus and methodology of the present invention include rechrgable lithium ion, lithium polymer, and lithium ion polymer (“gel”) batteries. Lithium ion batteries generally use carbon as the anode material, liquid electrolytes, such as mixtures of propylene carbonate, ethylene carbonate, and diethyl carbonate, and metal oxides, such as lithium cobalt oxide or lithium manganese oxide, as the positive active material. The anode active materials may also consist of alloys that alloy with lithium, such as tin, aluminim, and silicon, for example.

Lithum polymer batteries employ a solid polymer electrolyte as an alternative to the liquid electrolytes of lithium ion battaries. These batteries have lower ionic conductievities as compared to lithium ion batteries and thus usually operated at temperatures above ambient, such as 60-100° C. Lithium polymer batteries also offer advantages of a “non-liquid” battery and flexibility of configuration. The anodes of such batteries are lithium metal, electrolytes am typically crosslinked copolymers of polyethylenoxide, and cathods are metal oxides, such as lithium vanadium oxide.

Litbiun ion polymer gel batteries exhibit improved conductivity as compared with lithium polymer batteries by incorporating a plasticizer, such as propylene carbonate, into the solid polymer matrix. Lithium ion polymer gel batteries may be viewed as hybrids between the lithium ion and solid polymer batteries.

Nickel metal hydride batteries use hydrogen absorbed in a metal alloy in the form of a hydride for the active negative material. These alloys arc typically earth (e.g., Misch metal) based on ianthanum nickel or alloys based on titanium zironium. The active materal of the positive electrode is nickel oxyhydroxide. The electolyte is aqueus potassium hydroxide.

The electrochemical cells 15 emloyed in the cell stack assembly 28 depicted in the drawings are typically prismatic in configuration. The cells 15 genorally have two opposing planar surfaces that account for most of the cell's surface area relative to edges of the cells. For example, a typical cell 15 may be fabricated to have a length of approxtely 160 mm, a height of approximately 125 mm, and a thickness of only 9 mm. Another set of useful cell dimensions, in terms of inches, includes a surface area of about 5 inches by 5 inches and a thiclmess of about 0.33 inc.

The electrochemical cells 15 subject to cooling in accordance with the principles of the present invention need not have a prismatic configuration. By way of example, the electrochemical cells 15 may have a cylindrical shape or have a multifaced configuration (e.g., a hexagonal cross section). Tho electrochemical cells 15 can also have a rounded shape (e.g, an oval cross secton).

Maintaining uniform temperature of the cell stack assembly 28 and individual cells 15 is critical in preventing premature failure of te cell stack assembly 28. A typical string of cells constituing a given cell stack assembly 28 may, for example, include between 48 and 72 serially electrically conmected cells 15. 1t is readily appreciated by those skilled in the art that premature failure of any one of the cells 15 of a string of cells will render the entire cell string either inoperative or unacceptable in terms of energy output.

In the case of a cell stack assembly 28 comprising a string of lithium ion cells 15 employed in a given energy storage device, for example, the temperature control apparatus of the energy storge device must maintain the cells 15 at a uniform temperature during charge and discharge cycles to provide for optimal cell performance. By way of example, the temperature control apparatus must control the operating temperature of the cell stack assembly 28 such that a temperature difference as measured between any two cells of the cell stack or between any two points on either one of the opposing planar surfaces of an individual cell does not exceed 5 degrees Celsius. More preferably, a temperature difference as measured betwoen any two cells of the cell stack or between any two points on either one of the opposing planar surfaces of an individual cell should not exceed 2 degrees Celsius,

With regard to maintenance of the operating temperature of the cell stack assembly 28, a temperature difference as measured between any two points on either one of the opposing planar surface of an individual cell or between any two cells of the ceIl stack assembly 28 should not exceed 5 degres Celsius. More preferably, a temperature diference as measured between any two points on either one of tbs opposing planar suface of an individual cell or between any two cells of the cell stack asembly 28 should not exceed 2 degrees Celsius.

A factor that further omplicates the effort to provide effective temperature control of advanced rechargeable bataaries concerns cyclical changes in cell volume that occur in various types of such batteries. By way of example, the volume of a lithium polymer electrochemical cell of the type described previously varies during charge and discharge cycling due to the migration of lithium ions into and out of the lattice structure of the anode and cathode material. This migration creates a corresponding increase and decrease in total cell volume on the order of approximately five to six percent during charging and discharging respctively. Other types of advanced rechargable batteries (e.g., lithium ion, lithium ion polymer, ad nickel metal hydrie) likewise axhibit significant increases and decrease in total cell volume during charge and discharge cycling.

It is understood that the performance and survice-life of an electrochemical cell that undergoes repeated cycles of expansion and contraction is significantly increased by maintaining the layers/components of the cell in a state of compression. Improved cell performance may be realized by maintaining pressure on the two larger opposing surfaces of the cell during cell charge and discharge cycling. It is considered desirable that the compressive forces exerted on the cells be distributed fairly uniformily over the surface of application.

A cooling apparatus and methodology of the present invention provides the requisite level of temperature control needed to maximize the performance of advanced rechrgeable cells and strings/stacks of such cells. Moreover, a cooling apparatus and methodology of the peresent invention provides the requisite level of pressure control at as the cells undergo net external volumetric changes during operation. For eample, the cooling apparatus produce can produce pressures ranging between about 5 psi and about 60 psi as needed in a given application, It being understood that lower or higher pressures can be achieved if needed or desired. A cooling apparatus and methodology of the present invention provides a mechanism to maintain good thermal contact with the cells of the string/stack continuously and in the presence of significant cell volume changes during operation.

Returning to the figures, and more particularly to FIGS. 4 and 5, there is ilustrated two embodiments of a cooling apparatus well-suited for use with advanced rechargeable cells aid batteries. The cooling bladder 30 is fabricated from a resilient material which is sealed along the periphery to form one or more hollowed interior compartments. External access to the interior compartment(s) is achieved through attachment to inlet and outlet ports 31, 33. The cooling bladder 30 may be fitted with a single pair or multiple pairs of inlet and outlet ports 31, 33 depending on the number of interior compartments provided in the cooling bladder 30 and the desired number and direction on of flow pathways through the cooling bladder 30. As such, a cooling bladder 30 of the present invention may be configured to provide for one or more serial and/or parallel flow pathways troungh the cooling bladder 30.

In the configuration of a cooling bladder 30 shown in FIGS. 4A and 4B, inlet and outlet ports 31, 33 are respectively situated near opposing ends of the cooling bladder 30 and ae mounted on one of the two planar surfaces of the cooling bladder 30. FIG. 4A provides a side view of one of such top-mounted configurations. It is noted that the inlet and outlet ports 31, 33 need not be mounted on the same planar surface of the cooling bladder 30 as is shown in FIGS. 4A and 4B.

FIG. 4C is a detailed illustration of the mounting configuration of inlet and outlet ports 31, 33 to the cooling bladder 30 according to a top-mounted arrangement. The inlet and oatlet ports 31, 33 each include a threaded fitment or spout 37 which is mounted so that the fitment 37 pemetrates one of the two planar surfaces of the cooling bladder 30. A seal 35 is provided where the fitment 37 is mated to the cooling bladder surface. The fitment 37 and seal 35 can be selected from commercially available components depending on the particular design of a given energy storage device that incorporates a cooling bladder 30 of the present invention.

FIG. 5A illustrates another configuration of a cooling bladder 30 in which inlet and outlet ports 31, 33 are respectively situated at opposing ends of the cooling bladder 30. According to this side-mounted configuration, and as shown in the detailed depiction of FIG. 5B, inlet and outlet ports 31, 33 each include a threaded fitment 37 which is mounted so at the fitment 37 penetrates a side surface of the cooling bladder 30. A seal 35 is provided where the fitment 37 is mated to the cooling bladder surface. Ribbing may be incorporated to ensure a good seal between the fitment 37 and the cooling bladder surface. As in the configuration illustrated in FIG. 4C, the fitment 37 and seal 35 shown in FIG. 5B can be selected from commercially available components depending on the particular design of a given energy storage device that incorporates a cooling bladder 30 of the present invention.

For purposes of illustration and not of limitation, the cooling bladder 30 illustrated in FIGS. 4 and 5 can be fabricated to have a length of several feet. For example, the length of the cooling bladder 30 can range between 5 and 10 feet for many applications (e.g., 7 feet to 7.5 feet). The cooling bladder 30 can have a width of several inches. For example, the cooling bladder 30 can have a width ranging between 4 and 7 inches. Generally, the width of the cooling bladder 30 is designed to accommodate the width of the electrochemical cells employed in a given energy storage device. The cooling bladder's conformable thermally conductive material 30 can have a thickness that ranges between about 6 mils and 150 mils.

For example, an energy storage module may incorporate lithium ion prismatic cells having a width and height of about 5 inches and a thickness of about 0.33 inches. An appropriate width of the cooling bladder 30 for such 5″×5″ cells can range between 5 inches and 6 inches, with 5.5 iches being a suitable width. The length of the cooling bladder 30 is dependent on a number of factors, including the number of cells used in a cell stack assembly, the tolerance for temperature variations across a cell and the cell stack, ad the nunber of cell stack assemblies used in a given energy storage module, for example.

By way of example, a particular energy storage module may incorporate four cell stack assemblies each of which incorporates 12 electrochemical cells having dimensions of about 5″×5″×0.33″. In such a configuration, one cooling bladder 30 cam be employed to provide temperature control for a coresponding one of the four cell stack assemblies, for a total of four cooling bladders 30. Each of the cooling bladders 30 can have a length of about 7 feet-2 inches, and a width of about 5.5 inches.

One or more locations along the periphery of the cooling bladder 30 can be sealed to form the cooling bladder 30. For example, a ⅜ inch wide seal can be used at two peripheral locations along the sides of the cooling bladder 30 to provide sealing along the length of the cooling bladder 30. A ½ inch wide seal can be used at two peripheral locations along the ends of the cooling bladder 30 to provide sealing along the opposing ends of the cooling blader 30.

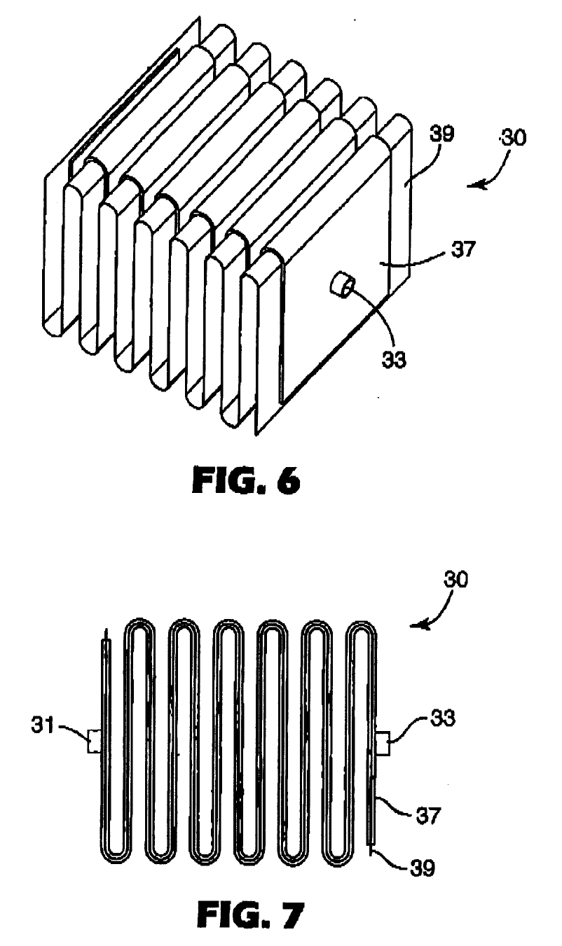

FIGS. 6 and 7 illustrate additional features of a cooling bladder 30 of the present inventiom. According to this illustration, the cooling bladder 30 includes an active region 37 and a sealed region 39. The active region 37 defines the unsealed portion of the cooling bladder 30 within which a heat transfer medium passes via inlet and outlet ports 31 and 33. The active region 37 thus represents the portion of the cooling bladder 30 that comes into thermal contact with the electrochemical cells and provides the requisite temperature control for the cells. As such, the width of the active region 37 of the cooling bladder 30 is designed to accommodate te width of the active region of the subject cells, The inactive sealed region 39 is shown to have a width that exceeds the width of the subject cells.

By way of example, and assuming use of 5″×5″ cells that have an active area of about 4.25″×4.25″, the active region 37 of the cooling bladder 30 can have a width of about 4.33″. The sealed region 39 can extend beyond the active region 37 by about 1.8″, such that the total width of the cooling bladder (width of active region 37 plus width of inactive region 39) is about 6.2 inches in this illustrative, non-liniiting example.

The active region 37 of the cooling bladder is generally designed to manage a maximum allowable amount of heat that is generated by a grouping of electrochemical cells during operation. The naximum allowable heat limit tpically takes into account the excess heat generated during a short circuit event within a cell string, and also varies depending on the availability of bypass circuitry or other short circuit control devices that limit the amount of heat generated by a short circuited cell or cells. For example a string of 12 cells may require that the cooling bladder 30 manage 18 W of heat dissipation per cell during normal operation. In this illustrative example, the cooling bladder 30 is to be designed to manage about 220 watt (i.e., Q=220 W) of heat dissipation from the string of 12 cels (12 cells×18 W/cell=216 W).

The heat transfer medium passing through the cooling bladder 30 is typically water or a combination of an anti-freeze and water (e.g., a blend of water and ethylene glycol or a mixture of methanol and ethylme glycol). The rate of heat transfer medium flow through the cooling bladder 30 is dependent onto heat dissipation rquirement of a given string of cells. For a cooling bladder 30 having dimensions discussed above with reference to FIGS. 6 and 7 and a heat dissipation requirement of about 220 W and a maximum temperature diffrence of 2° C., flow rates of water though the cooling bladder 30 of about 0.06 kg/sec to about 0.07 kq/sec may be sufficient.

It is desirable that the temperature of the heat transfer medium supplied to the cooling bladder 30 be substantilly constant. This desired requirement simplifies the design and performance requirements of the cooling bladder 30. In an implementation in which energy storage modules equipped with coolig bladders 30 of the present invention are deployed in an electric or hybrid-electric vehicle, the vehicle preferably includes a battery coolant circuit that supplies a heat transfer medium (i.e., coolant) to the cooling bladders 30 of each energy storage module at a substantially constant temperature. The batery coolant circuit may either be separate from or be connected to the vehicle's main coolant system. The coolant passed out of the energy storge modules typically returns to the battery coolant circuit or the main coolant system, depending on the design of the vehicle and its cooling system. The returned coolant is brought back to the predetermined supply temperature prior to being supplied to the energy storage modules.

It is understood that the design and implementation of an effective temperature control apparatus of the present invention depends on numerous factors uinque to a given application. Such factors include, for example, cooling bladder dimensions ad thermal conductance properties; heat transfer medium properties, flow rate, and entry temperature; energy storage device insulation and thermal environment of use, cell energy dissipation characteristics, and coolant system specifications (e.g., coolant supply temperature), among others.

ln many applications, volume and weight limits are specified for the energy storing device to be used in a given application. For example, a given manufacturer of electric-hybrid vehicles may specify that the vehicle's battery cannot exceed a volume of 32 liters and a weight of 40 kilograms. In order to maximize the available volume and weight of the battery allotted to the energy producing components of the battery, it is highly desirable to minimize the volume and weight of the temperature control components of the battery.

A temperature control apparatus that employs a cooling bladder of the present invention advantageously maximizes temperature control performance for high energy, high power density batteries, while minimizng weight and volume requirements. For example, a cooling bladder of the present invention and the heat transfer mediun passing through it constitute less than about 50% by weight or volume of a total aggregate weight or volume of the cells, cooling bladder. and heat transfer medium. Those skilled in the art will readily appreciate the adntages of low weight and volume overhead offered by a cooling apparatus of the present invention in comparison to conventional cooling approaches.

The material used in the fabrication of the cooling bladder 30 may be a single layer material or a multiple layer material. In the case of a single layer material, the cooling bladder 30 may be constructed using a resilient material having good thermal conduction properties, such as ELVAX (ethylen-vinyl acetate copolymer, DuPont, Wilmington, De.) or low density polyethylene (LDPE).

In the case of a multiple layer material the cooling bladder 30 may be fabricated using a number of different multi-layer materials having good thermal conduction properties. The cooling bladder 30 may, for example, be fabricated using a three layer construction. According to one configuration, a metallic layer is disposed between a first polymer layer and a second polymer layer. By way of example, a thin metallic foil, such as aluminum foil, can be used to miniize the moisture vapor transrnssion rate (MVTR) over the life of the cooling bladder 30 and exhibits good conformability and thermal conductivity properties. A heat sealable film such as polyetbylene is disposed on a first face of the metallic foil. A protective film, such a nylon or polypropylene, is disposed in a second face of the metallic foil. The threelayer material can be sealed using known sealing techniques to form the cooling bladder 30. According to another configuration, the cooling bladder 30 may be fabricated using a PET-metal material in contact with a layer of ethylenevinyl acetate copolymer (e.g., ELVAX, mnufactured by Dupont).

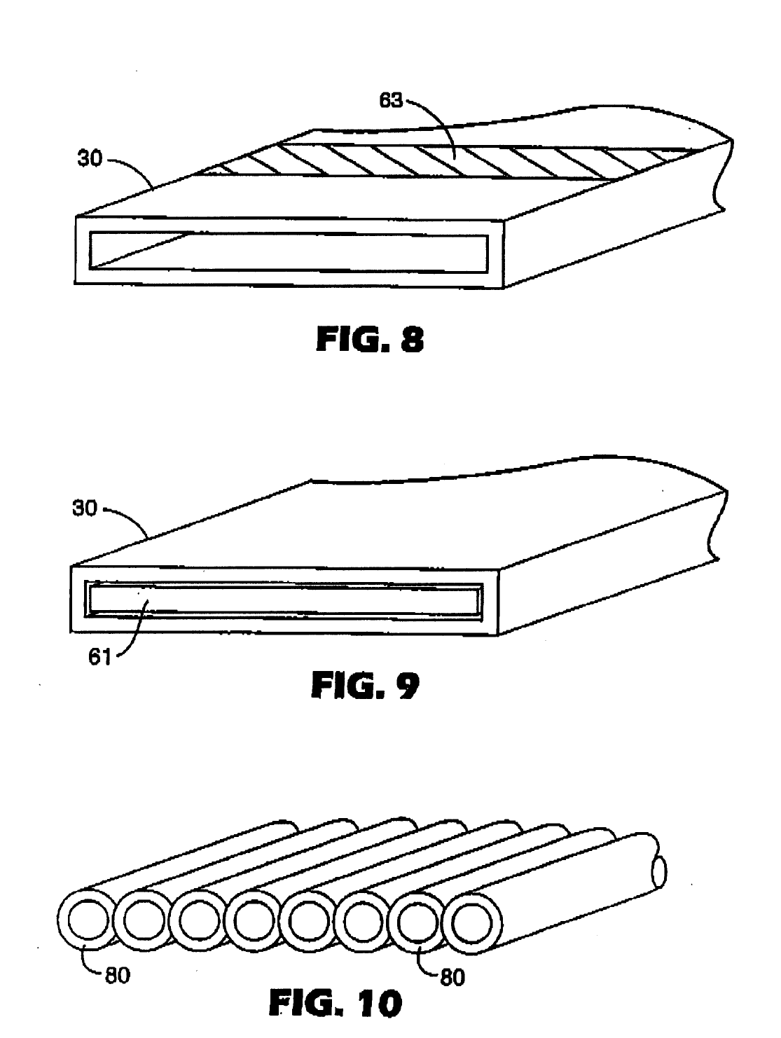

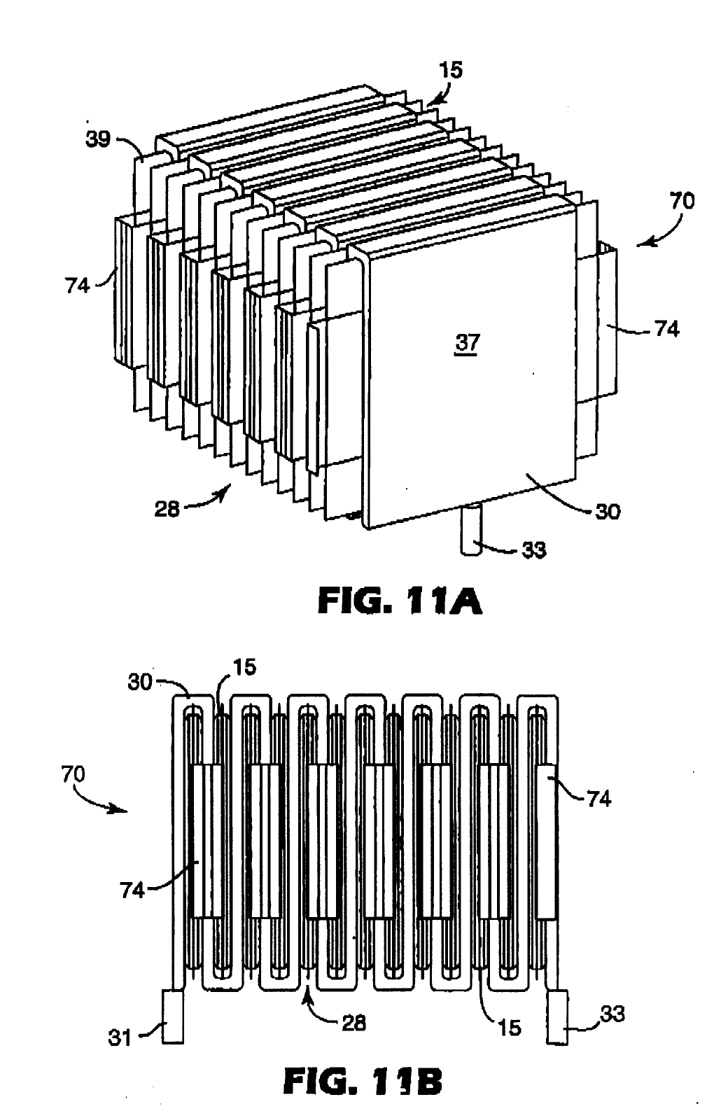

FIGS. 8-10 illustrate several embodiments of a cooling bladder 30 in accordance with the principles of the present invention. FIGS. 8 and 9 depict embodiments in which a cooling bladder has the form of a flexible pouch. The cooling bladder 30 illustrated in FIGS. 8 and 9 is shown to have a rectangular cross section for simplicity of explanation. The cooling bladder 30 depicted in FIG. 10 comprises a number of flow channels 80, such as a bank of tubes. The flow chnnels 80 may be of any configuration, and may have circular, rectangular, square or tiangular cross sections, for example.

The cooling bladder 30 depicted in FIG. 8 includes a hollowed interior, while the cooling bladder 30 shown in FIG. 9 incorporates a filler 61 within the hollowed interior. In certain applications, the cooling bladder 30 may be subject to tight bends. Excessive bending of the cooling bladder 30 can reult in an undesirable decrease in the flow rate of the heat transfer medium within the cooling bladder 30. Increased back pressure caused by such restrictions can be detrimental to the supply apparatus that dispenses the pressurized heat transfer medium to the inlet port of the cooling bladder 30.

In order to reduce the tendency for cooling bladder wall collapse or kinking at tight bend locations, a filler 61 may be incorporated within the cooling bladder 30. The filler 61 is preferably disposed at locations of the cooling bladder 30 which are likely to be subjected to excessive bending. The filler 61 prevents heat transfer medium flow from being interrupted around low radius bonds and prevents pinching off of heat transfer medium flow within the cooling bladder 30. Alternatively, the filler 61 may be disposed within the entire length of the cooling bladder 30.

The filler 61 is fabricated from a material that is capable of resisting collapse of the cooling bladder wall when subject to the bending. In this regard, the filler 61 shown in FIG. 9 provides support to the cooling bladder structure from within the cooling bladder 30. In addition, the filler 61 induces turbulent flow mixing that enhances heat transfer between the cooling bladder 30 and electochemical cells. The filler 61 is preferably fabricated from a porous material. Suitable filler materials include carbon, metal, plastic, composites, nylon, polyester, Scotcl-Brite™ (3M, St. Paul, Minn.) or other nonwoven material.

In another configuration, support for the cooling bladder structure can be provided by an arrangement external to the cooling bladder 30, such as by use of a sleeve 63 of a resilient reinforcing material attached to the exterior surface of the cooling bladder 30, as is shown in FIG. 8. Also, portions of the cooling bldder 30 designed to bend for a given application can be thickened reative to other portions of the cooling bladder 30 as part of cooling bladder fabrication,

As was discussed previously, the cooling bladder or bladders used within an energy stage device may provide for serial or parallel flows. FIGS. 11A and 11B illustrate an embodiment in which a cooling bladder 30 is integrated within a cell stack assembly 28 to provide for serial coolant flow through the cooling bladder 30. FIGS. 11A and 11B show a string of electrochemical cells 15 arranged in a spaced apart relationship to form the cell stack assembly 28. The cooling bladder 30 is assembled in a “fan-folded” fashion such that the active region 37 of the cooling bladder 30 contacts the active heat producing region of the cells 15. As shown, the cooling bladder 30 takes on a serpentine shape when it is installed within the cel stack assembly 28.

Wben the sub-assembly of the cell stack assembly 28 fitted with the cooling bladder 30 is properly instaled within an energy storage module houing, electrical connections between cell tabs 74 and tabs of a circuit board or interconect board are properly established. The inlet and outlet ports 31, 33 ar respectively connected to supply and return lines (not shown) of an external cooling system. During operation, a heat transfer medium passes through the inlet port 31, through the interior compartent of the cooling bladder 30, and passes out to the cooling bladder 30 via the outlet port 33 in a serial manner.

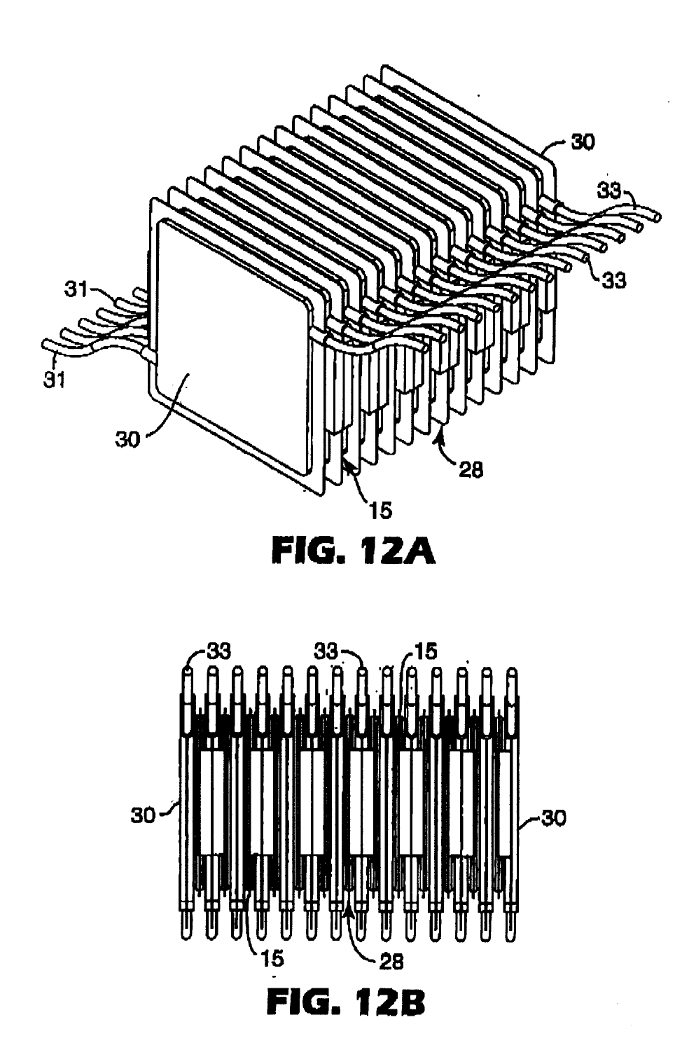

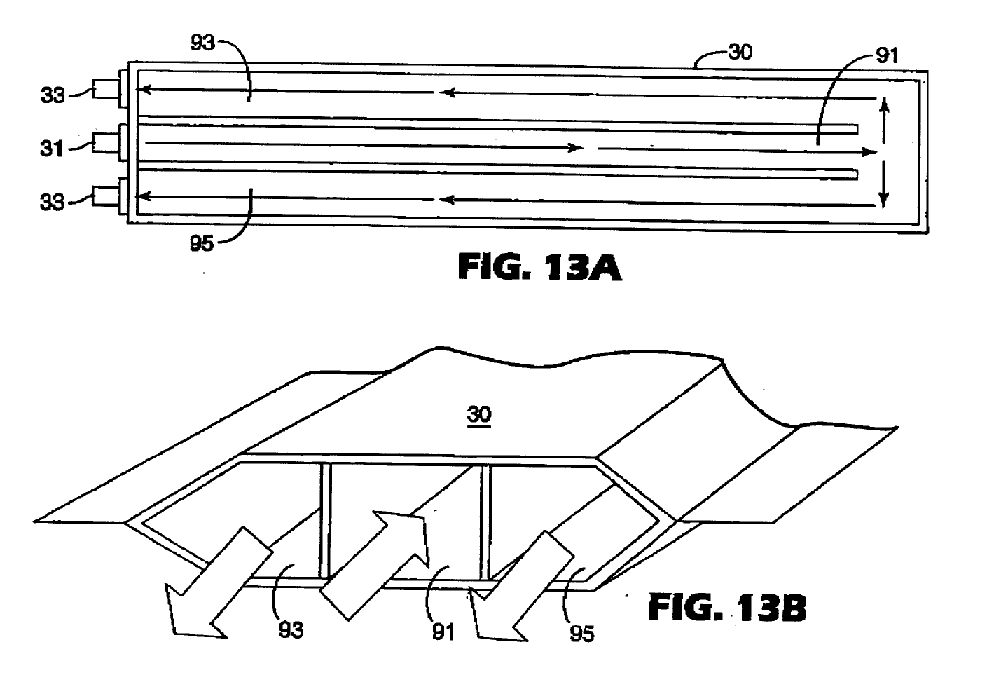

FIGS. 12A and 12D illustrate an embodiment in which a cooling bladder 30 is integrated within a cell stack assembly 28 to provide for multiple serial coolant flow pathways. In the configuration depicted in FIGS. 12A and 12B, a number of independent cooling bladders 30 are integrated within the string of electrochemical cells 15 of the cell stack assembly 28. As shown, each electrochemical cell 15 is sandwiched between two independent cooling bladder 30. It is noted that the inlet and outlet ports 31, 33 of the cooling bladders 30 are typically coupled to common supply and return lines of the coolant system for simplicity of design.

A variety of cooling bladder configurations may be achieved to provide optimal temperature contol for energy storage systems of varying types. For example, several cooling bladders 30 may be integrated in a serpentine fashion within a single cell stack assembly 28, rather than using a single cooling bladders 30 as shown in FIG. 11. Parallel flows within one or more cooling bladder 30 may be achieved by provision of multiple inlet compartments within the cooling bladders 30 and appropriate provision of inlet ports 31 relative to outlet ports 33. For exaple, the cooling bladder 30 shown in FIGS. 11 and 12 may each be fabricated to include multiple interior compartments, such that coolant supplied to an interior component via a single inlet port 31 flows into two or more compartments that each terminate with an outlet port 33.

A simple parallel flow arrangement as iliustrated in FIGS. 13A and 13B, may, for example, be achieved by provision of one inlet port 31 that supplies coolant to a supply compartment 91 of the cooling bladder 30 so that coolant flows through the supply compartment 91 in one direction. As best seen in FIG. 13B, the cooling bladder 30 is partitioned to include two return compartments 93, 95 that are respectively separated from the supply compartment 91 but fluidly connected to the end of the supply compartment 91 (see FIG. 13A in particular). The ends of each of the two return compartments 93, 95 are fitted with respective outlet ports 33.

A heat transfer medium flows through the supply compartment 91 via the inlet port 31 in a first direction until reaching the end of the supply compartment 91. The heat transfer medium flow is then split into two flows at the location at which the supply compartment 91 fluidly connects with the two return compartments 93, 95. The two flows pass through respective return compartments 93, 95, typically in directions opposite to that of the supply compartment flow, and exit the cooling bladder 30 via respective outlet ports 33. It will be appreciated by those skilled in the art that other flow enhancement features (e.g., adding perforations/apertures to the walls separating the supply and return compartments) may be incorporated into te cooling bladder to further enhance temperature uniformity.

In certain applications, particularly those involving electric or hybrid-electric vehicle, it is important that the cooling apparatus transport heated coolant to the electrochemical cells in a timely manner during cold start situations. For example, the temperature of a given hybrid vehicle battery may be well below a specified operating temperture at the time the operator whishes to initiate vehicle operation. In this situation, it is desirable to bring the battery up to the specified operating temperature as fast as possible. This can be achieved by provision of a cold start electrial heating element that quickly heats the coolant to the required temperature.

This heating element is preferably operative during cold start situations, and may no longer be required once the coolant system comes up to temperature. A flow of quickly warmed coolant is supplied to the cooling bladders 30 of the battery until the battery comes up to the specified operating temperature. During subsequent operation of the vehicle, the heating element may be operated as required to maintain the set temperature.

It is desirable that the duration of time required to bring a battery to a specified operating temperature in a cold start situation be as short as possible. This duration of time can be characterised by a time constant. A time constant is generally defined as tbe time it takes a given process to reach a steady state condition when starting from an initial startup condition. Within the context of the present invention, the condition is the desired operating temperature, and the time constant is dependent on a number of factors, including ambient air temperature, heating element wattage, coolant type, coolant amount and coolant flow rate, and battery type and battrry thermal mass, among other factors. It is preferable to obtain a time constant as low as possible, preferably less than a few minutes.

The foregoing description of the various embodiments of the invention has been presented for the purposes of illustraion and description. It is not intended to be exhaustive or to limit the invention to the precise form disclosed. Many modificaions and variations arm possible in light of the above teaching. For example, a cooling apparatus and methodology of the present invention can readily be adapted to apply to eletrochemical cells of a variety of shapes or size. One example involves weaving the cooling bladder among cylindrical shaped cells arranged in a spaced apart relationship. The cooling bladder can bo configured for example, to partially or cmpletely encompass the circumferential surface area of such cylindric shaped cells. Other examples involve weaving the cooling bladder among multifaceted (e.g., a bexagonal cross sectioned) or rounded (e.g., oval cross sectioned) shaped electtrochemical cells. It is intended that the scope of the invention be limited not by this detailed description, but rather by the claims appended hereto.

1. An electrochemical storage device, comprising:
a plurality of electrochemical cells arranged in a spaced apart relationship, each of he electrochemical cells comprising opposing first and second planar surfaces and subject to volumetric changes during charge amd discharge cycling; and
a cooling bladder formed of a conformable thermally conducting material and having an inlet port and an outlet port, the cooling bladder conformable to maintain contact with at least the first planar surface or the second planar surface of each of the electrochemical cells during the volumetric changes, a heat transfer medium passing between the inlet and outlet port to control au operating temperature of the electrochemical cells.

2. The device of claim 1, wherein the cooling bladder compprises a continuous hollowed interior within which the heat transfer medium passes.

3. The device of claim 1, wherein the cooling bladder comprises a plurality of flow channels within which the heat transfer medium passes.

4. The device of claim 1, wherein the cooling bladder covers substantially all of a surface area of each of the cells.

5. The device of claim 1, wherein the cooling bladder comprises a support arrangement that inhibits restriction of heat fer medium flow at cooling bladder bend locaions.

6. The device of claim 5, wherein the support arrangement is located on an outer surface of the cooling bladder at the cooling bladder bend locations.

7. The device of claim 5, wherein tbe support arrangement is located within the cooling bladder at the cooling bladder bend locations.

8. The device of claim 1, wherein the cooling bladder comprises a porous filler material disposed within tbe cooling bladder.

9. The device of claim 1. wherein the cooling bladder comprises a porous filler material disposed at cooling bladder locations subject to bending.

10. The device of claim 1, wherein the cooling bladder comprises thickened sections provided at cooling bladder locations subject to bending.

11. The device of claim 1, wherein the cooling bladder comprises an interior compartment within which the heat transfer medium passes between the inlet port and the outlet port in a unidirectionl manner.

12. The device of claim 1, wherein the cooling bladder comprises a plurality of compartments through which the heat transfer medium passes.

13. The device of claim 1. wherein the cooling bladder comprises a first interior compartment and a second interior compartment, the transfer medium passing within the first interior compartment in a direction opposing that of the trasfer medium passing widtwi the second interior compartment.

14. The device of claim 1, wherein the conformable thermally conductive material comprises a single material layer.

15. The device of claim 1, whorein the conformable thermally conductive material comprises a plurality of material layers.

16. The device of claim 1, wherein the conformable thermally conductive material comprises a metallic layer disposed between a first polymer layer and a second polymer layer.

17. Tha device of claim 1, wherein the conformable thermally conductive material of the cooling bladder has a thickness of less than about 150 mils.

18. The device of claim 1, wherein the cooling bladder and the heat transfer medium constitute less than about 50% by weight or volume of a total aggregate weight or volume of the cells, cooling bladder, and heat transfer modium.

19. The device of claim 1, when the plurality of electrochemical cells are arranged to form a plurality of cell sets, each of the cell sets provided with one of a plurality of the cooling bladders, sudh tiat an operating temperature of electrochemical cells of each of the cell sets is controlled by at least one of tbe plurality of cooling bladders.

20. The device of claim 1, wherein the plurality of electrochemical cells are arranged to forn a cell stack, and the cooling bladder controls the operating temperature of the cell stack such that a temperature difference as measured between auy two cells of fte cell stack does not exceed 5 degrees Celsius.

21. The device of claim 1, wherein the plurality of electrochemical cells are arranged to form a cell stack, and the cooling bladder controls the operating temperature of the cell stack such that a tamperature difference as measured between any two points on either the first or second planar surface of an individual cell does not exceed 5 degrees Celsius.

22. The deice of claim 1, wherein the plurality of electrochemical cells are arranged to form a cell stack, and the cooling bladder controls the operating temperature of the cell stack such that a temperature difference as measured between any two cells of the cell stack or between any two point on either the first or second planar surface of an individual cell does not exceed 2 degrees Celsius.

23. The devic of claim 1, wherein the cooling bladder conforms to a serpentine configuration to contact the respective first and sctond planar surfaces of each of the electrochemical cells.

24. The device of claim 1, wherein:
each of the plurality electrochemical cells comprises first, second, third, and fourth edges, thP first edge opposing the second edge and the third edge the fourth edge;
the first and second edges of euch oleetrochemical cell electrically couples to respective electrical conductors for conducting current into and out of euch of the electrochemical cells; and
the cooling bladder contacts respective third and fourth edges and respective first and second planar surfaces of each of the electrochemical cells.

25. The device of claim 1, wherein the heat transfer medium comprises water.

26. The device of claim 1, wberein the heat transfer medium comprises a mixture of water and ethylene glycol.

27. The device of claim 1, wherein a temperature of the heat transfer medium entering the inlet port of the cooling bladder is substantially constant.

28. The device of claim 1, wherein the operating temperature of the elctrochemical cells ranges between about 20 degrees Celsius and about 130 degrees Celsius.

29. The device of claim 1, further comprising a houing within which the plurality of electrochemical cells and the cooling bladder are situated the housing comprising a positive terminal and a negative terminal each coupled to the electrochemical cells, the housing of comnprising an inlet aperture for providing access to the inlet port of the cooling bladder and an outlet aperture for providing access to the outlet port of the cooling bladder.

30. The device of claim 1, further comprsing a housing within which the plurality of electrochemical cells and a plurality of the cooling bladders are situated, the housing comprising a positive terminal and a negative terminal each coupled to the electrochemical cells, the housing further comprising at least one inlet aperture for providing access to an inlet port of each of the cooling bladders and at least one outlet aperture for providing access to an outlet port of each of the cooling bladders.

31. The device of claim 1, wherein the electrochemical cells comprise lithium cells or nickel metal hydride cells.

32. An electrochemical storage device, comprising:
a plurality of electrochemiical cells arranged in a spaced apart relationship, the electrochemical cells comprising opposing first and second planr surfaces, the electrochemical cells subject to volumetric changes during charge and discharge cycling; and
a cooling bladder formed of a conformable thermally conductive material, the cooling bladder conformable to contact at least the repective first planar surface or second planar surface of each of the electrochemical cells, a heat transfer medium passing within the cooling bladder to control an operating temperature of the electrochemical cells, the cooling bladder pressurized to maintain the electrochemical cells in a state of compression during charge and discharge cycling.

33. The dcvice of claim 32, wherein the cooling bladder comprises a plurality of flow channels within which the heat transfer medium passes.

34. The device of claim 32, wherein the cooling bladder comprises a support arrangememt that inhibits restriction of heat transfer medium flow at cooling bladder bend Iocations.

35. The device of claim 34, wherein the support arrangement is located on an outer surface of the cooling bladder at the cooling bladder bend locations.

36. The device of claim 34, wherein the support arrangement is located within tbo cooling bladder at the cooling bladder bend locations.

37. The device of claim 32, wherein the cooling bladder comprises a porous filler material disposed within the cooling bladder.

38. The device of claim 32, wherein the cooling bladder comprises thickend sections provided at cooling bladder locations subject to bending.

39. The device of claim 32, wherein the cooling bladder comprises a plurality of compartments through which the haat medium posses.

40. The device of claim 32, wberein the conformable thermally conductive material comprises a single material layer.

41. The device of claim 32, wharein the conformable thermally conductive material comnrises a plurality of material layer.

42. The device of claim 32, wherein the conformable thermally conductive material of the cooling bladder has a thickness of less than about 150 mils.

43. The device of claim 32, wherein the plurality of electrochemical cells are arranged to form a plurality of cell sets, each of the cell sets provided with one of a plurality of the cooling bladders, such that an operating teperature of electrochemical cells of each of the cell sets is controlled by at least one of the plurality of cooling bladders.

44. The device of claim 32, wherein the plurality of eletochemical cells are arranged to form a cell stack, and the cooling bladder controls the operating temperature of the cell stack such that a temperature differece as measured between any two cells of the cell stack does not exceed 5 degrees Celsius.

45. The device of claim 32, wherein the plurality of electrochemical cells are arranged to form a cell stack, and the cooling bladder controls the operating temperature of th cell stack such that a tenperature diffenrce as measured between any two points on either the first or second planar surface of an individual cell does not exceed 5 degrees Celsius.

46. The device of claim 32, wherein the cooling bladder conforms to a serpentine configuration to contact the respective first and second planar surfaces of each of the electrochemical cells.

47. The device of claim 32, wherein:
each of the plurality of electrochemical cells comprises first, second, third, and fourth edges, the first edge opposing the second edge and the third edge opposing the fourth edge;
the first and second edges of each electrochemical cell electrially couples to respective electrical conductors for conducting current into and out of each of the electrochemical cells; and
the cooling bladder contacts respective third and fourth edges and respective first and second planar surfaces of each of the electrochemical cells.

48. The device of claim 32, wherein the operating temperature of the electrochemical cells ranges between about 20 degrees Celsius and about 130 degrees Celsius.

49. The device of claim 32. further comprising a housing within which the plurality of electrochemical cells and the cooling bladder are sitated, the housing comprising a positve terminal and a negative terminal each coupled to the eletrochemical cells, the housing further comprising an inlet aperture for providing access to the inlet port of the cooling bladder and an outlet aperture for providing access to the outlet port of the cooling bladder.

50. The device of claim 32, further comprising a housing within which the plurality of electrochemical cells and a plurality of the cooling bladders are situated, the housing comprising a positive terminal and a negative terminal each coupled to the electrochemical cells, the housing furthier comprising at least one inlet aperture for providing access to an inlet port of each of the cooling bladder and at least one outlet aperture for providing access to an outlet port of each of the cooling bladders.

51. The device of claim 32, wherein the electrochemical colls comprise lithium cells or nickel metal hydride cells.

52. A method of providing cooling within an electrochemical storage davice, comprising:
providing a plurality of electrocemical cells arranged in a spaced apart relationship, each of the electrochemical cells comprising opposing first and second planar surface and subject to volumetric changes during charge and discharge cycling;
providing a conformable, the conductive cooling bladder such that the cooling bladder maintains contact with at least the first planar suface or the second planar surface of each of the electrochemical cells during the volumetric changes; and
passing heat transfer medium through the cooling bladder to control an operating temperature of the electochemical cells.

53. The method of claim 52. further comprising pressurising the cooling bladder to maintain the eleclochemical cells in a state of compression during call charge and discharge cycling.

54. The method of claim 52, wherein passing the heat transfer medium further comprises passing the heat transfer medium through the cooling bladder in a unidirectional manner.

55. The method of claim 52, wherein passing te heat transfer medium furtber comprises passing the heat transfer medium through a plurality of oompartments provided within the cooling bladder.

56. The method of claim 52, further comprising supporting the cooling bladder at cooling bladder bend locations to inhibit restriction of heat transfer medium flow at the cooling bladder bend locations.

57. The method of claim 57, wherein supporting the cooling bladder further comprises using a porous filler material within the cooling bladder to support the cooling bladder at the cooling bladder bend locations.

58. The method of claim 52, wherein the plurality of electrochemical cells are arranged to form a plurality of cell sets, each of the cell sets provided with one of a plurality of the cooling bladders, further wherein passing the heat transfer medium comprises passing the heat transfer medium through each of the cooling bladder to control an operating temperature of the electrochemical cells of each of the cell sets.

59. The method of claim 52, wherein the plurality of clectrochemical cells are arranged to form a cell stack, further wherein passing the heat transfer medium comprises passing the heat transfer medium through the cooling bladder to control the operating temperature of the cell stack such that a temperature difference as measured between any two cells of the cell stack does not exceed 5 degrees Celsius,

60. The method of claim 52, wherein the plurality of electrochemical cells are arranged to form a cell stack, wherein passing the heat transfer medium comprises passing the heat transfer medium through the cooling bladder to control the operatiog temperature of the cell stack such that a temperature difference as measured between any two points on either the first or second planar surface of an individual cell does not exceed 5 degree Celsius.

61. The method of claim 52, wherein the heat transfer medium comprises water or a mixture of water and ethylene glycol.

62. The method of claim 52, wherein passing the heat transfer medium comprises passing the heat transfer medium at a substantally constant temperature into the cooling bladder.

63. The method of claim 52, wherein the operating tunperature of the electrochemical cells ranges between about 20 degrees Celsius and about 130 degrees Celsius.

64. The method of claim 52, wherein the electrochemical cells comprise lithium cells or nickel metal hydride cells.

65. The method of claim 52, further comprising providing a housing within which the plurality of electochemical cels and the cooling bladder are situated, the housing comprising a positive terminal and a negative terminal each coupled to the electrochemical cells, the housing further comprising an inlet aperture for providing access to the inlet port of the cooling bladder and an outet aperture for providing access to the outlet port of the cooling bladder, further wherein passing the heat transfer medium comprises passing the heat transfer the heat medium through the inlet aperture of the housing, the inlet and outlet ports of the cooling bladder, and the outlet aperture of the housing.

66. The method of claim 52, further comprising providing a housing within which the plurality of electrochemical cells and a plurality of the cooling bladders are situated, the housing comprising a positive terminal and a negative terminal each coupled to the electrochemical cells, the housing further comprising at least one inlet aperture for providing access to an inlet port of each of the cooling bladders and at lenst one outlet aperture for providing access to an outlet port of each of the cooling bladders, further wherein passing the heat transfer medium comprises passing the heat transfer medium through the at least one inlet aperture of the housing, the inlet and outlet ports of the respective cooling bladders, and the at least one outlet aperture of the housing.
